(19) United States
(12) Patent Application Publication
(10) Pub. No.: US 2025/0131254 A1
(43) Pub. Date: Apr. 24, 2025

(54) COMPOSABLE FUNCTION-PRESERVING EXPANSIONS OF NEURAL NETWORKS

(71) Applicant: DeepMind Technologies Limited, London (GB)

(72) Inventors: Kaitlin Marguerite-Lois Maile, Toulouse (FR); Andrea Gesmundo, Zürich (CH)

(21) Appl. No.: 18/924,844

(22) Filed: Oct. 23, 2024

Related U.S. Application Data
(60) Provisional application No. 63/592,868, filed on Oct. 24, 2023.

(51) Int. Cl. G06N 3/0499; G06F 17/16; G06N 3/084

(52) U.S. Cl. CPC G06N 3/0499; G06F 17/16; G06N 3/084

(57) ABSTRACT

Methods, systems, and apparatus, including computer programs encoded on computer storage media, for training a neural network. In one aspect, the method includes: obtaining a baseline architecture for the neural network; generating an expanded architecture for the neural network; and training the neural network having the expanded architecture.

### CROSS-REFERENCE TO RELATED APPLICATION

This application claims priority to U.S. Provisional Application No. 63/592,868, filed on Oct. 24, 2023. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of weights.

Training state-of-the-art neural networks requires a high cost in terms of compute and time. Moreover, model scale is recognized to be a critical factor to achieve and improve the state-of-the-art. Increasing the scale of a neural network normally requires restarting from scratch, e.g., from randomly initialized values of the weights of the neural network.

### SUMMARY

This specification describes a system implemented as computer programs on one or more computers in one or more locations that trains a neural network to perform one or more machine learning tasks on a network input.

The subject matter described in this specification can be implemented in particular embodiments so as to realize one or more of the following advantages.

This specification describes a system that implements a continual training framework suitable for training a neural network, e.g., a Transformer-based neural network, that has an ever growing model size. By progressively (e.g., at each of multiple time points throughout the training process) expanding the neural network to include additional sets of weights while imposing initialization constraints on the additional sets of weights, the described system expands the capability of the neural network while preserving the previous knowledge that has been learned by the neural network.

Accordingly, the described system can train a neural network to achieve or even exceed the state-of-the-art on any of a variety of tasks, despite a training process that consumes fewer computing resources, is faster in terms of wall-clock time, or both, than conventional systems that do not impose such initialization constraints, or that restart the training of each new model from randomly initialized weights values. Examples of tasks that the neural network can be trained to perform well (by virtue of having a greater model size) include natural language processing (NLP) tasks, including machine translation, text generation, and question answering and further include tasks in other domains, including computer vision tasks, speech recognition tasks, and content recommendation tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example neural network.

FIG. 1B shows an example neural network training system.

FIG. 2 is an example illustration of a baseline architecture for a neural network.

FIG. 3 is a flow diagram of an example process for training a neural network using a continual training framework.

FIG. 4 is a flow diagram of sub-steps of one way of performing one of the steps of the process of FIG. 3.

FIG. 5 is a flow diagram of sub-steps of another way of performing one of the steps of the process of FIG. 3.

FIG. 6 is a flow diagram of sub-steps of another way of performing one of the steps of the process of FIG. 3.

FIG. 7 is a flow diagram of sub-steps of another way of performing one of the steps of the process of FIG. 3.

FIG. 8 is a flow diagram of sub-steps of another way of performing one of the steps of the process of FIG. 3.

FIG. 9 is a flow diagram of sub-steps of a further way of performing one of the steps of the process of FIG. 3.

Like reference numbers and designations in the various drawings indicate like elements.

### DETAILED DESCRIPTION

This specification describes a neural network training system implemented as computer programs on one or more computers in one or more locations that obtains data specifying a baseline architecture of a neural network and implements a continual training framework to train the neural network. Under the continual training framework, the baseline architecture of the neural network is progressively expanded throughout training to enable efficient training pipelines for larger and more powerful models.

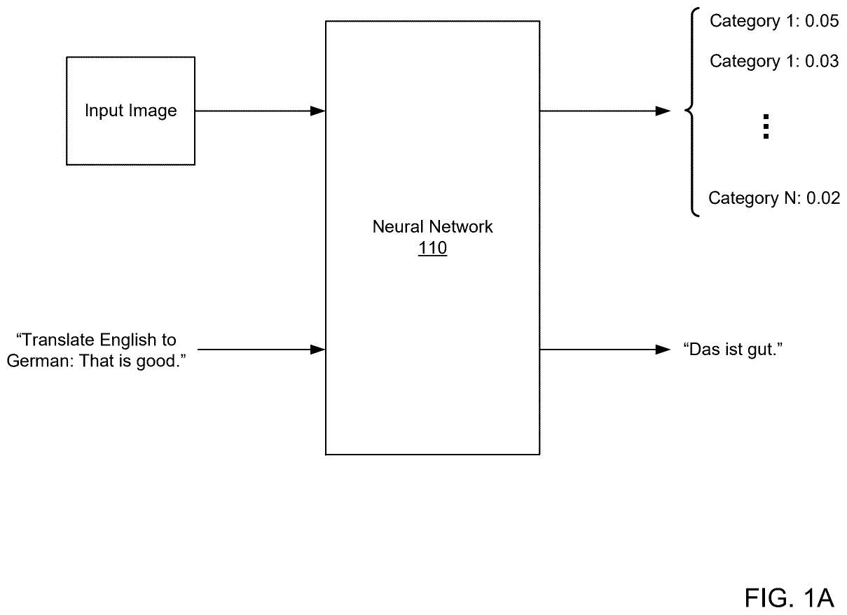

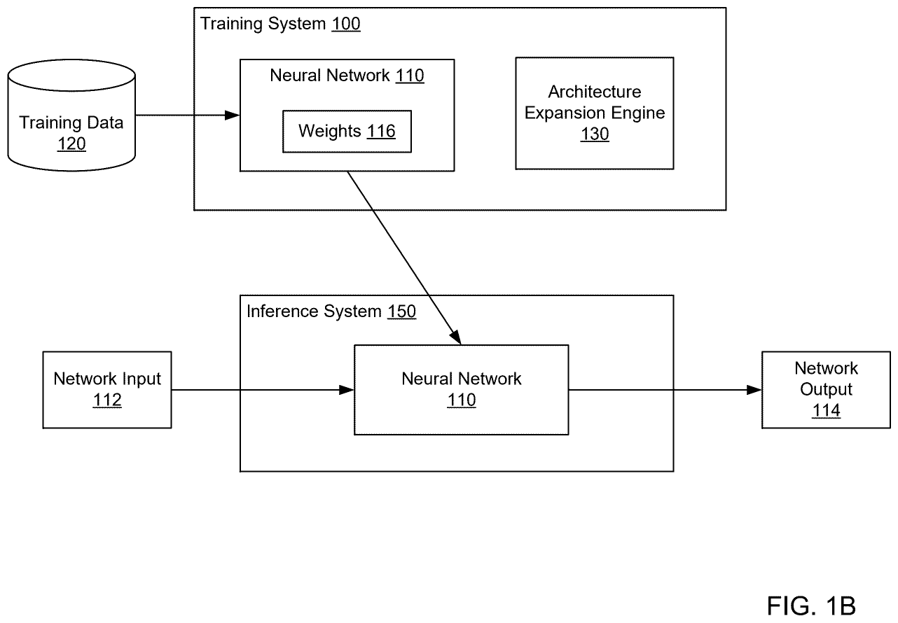

FIG. 1A shows an example neural network 110. The neural network 110 is an example of a neural network having an expanded architecture that can be generated from a baseline architecture of the neural network by using the techniques described throughout this specification.

In some situations, the neural network 110 can be referred to as an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the neural network 110 can be an auto-regressive Transformer-based neural network that includes (i) a plurality of attention blocks that each apply a self-attention operation and (ii) an output subnetwork that processes an output of the last attention block to generate the score distribution. In implementations the neural network may be configured as, or include, a generative (large) language model or a multi-modal model, e.g., a visual and language model, to perform these example machine learning tasks.

The neural network 110 can be configured through training to receive any kind of digital data input and to perform any kind of machine learning task (e.g., generative task, classification task, or regression task) on the input to generate an output. A few examples follow.

In some cases, the neural network is a neural network that is configured to perform an image processing task, i.e., receive an input image and to process the input image to generate a network output for the input image. For example, FIG. 1A illustrates that the task may be image classification and the output generated by the neural network for a given input image may be scores for each of a set of object categories, e.g., category 1, category 2, and so on, up to category N, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. For example, FIG. 1A illustrates that the input to the neural network is a sequence of text in English: “Translate English to German: That is good.” and the output generated by the neural network is a translation of the sequence of text into German: “Das ist gut.” As a particular example, the task may be a multi-lingual machine translation task, where a single neural network is configured to translate between multiple different source language-target language pairs. In this example, the source language text may be augmented with an identifier that indicates the target language into which the neural network should translate the source language text.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv:2209.14375) or Chinchilla (Hoffmann et al. arXiv:2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed. FIG. 1B shows an example training system 100 and an example inference system 150. The training system 100 and the inference system 150 are examples of a system implemented as computer programs on one or more computers in one or more locations, in which the systems, components, and techniques described below can be implemented.

The training system 100 includes a neural network 110. The neural network 110 is a neural network that can be configured through training to perform any one of the tasks mentioned above by processing a network input in accordance with a set of weights 116 of the neural network 110 to generate a network output for the task. For example, the weights 116 of the neural network 110 include weights and, optionally, biases of the layers of the neural network.

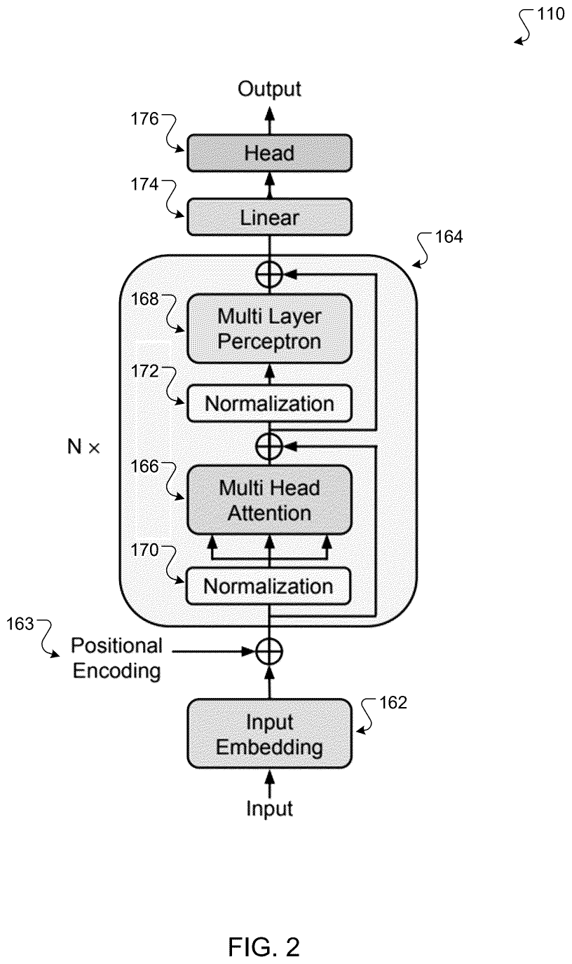

FIG. 2 is an example illustration of a baseline architecture for the neural network 110. In implementations the baseline architecture can be similar to any one of a variety of Transformer-based neural network architectures. The neural network 110 has an input embedding layer 162, followed by a positional encoding layer 163, followed by a sequence of N attention blocks 164, followed by a linear layer 174, and followed by an output head 176. Generally, a “block” refers to a group of one or more neural network layers in a neural network. N can be any integer equal to or greater than one.

The input embedding layer 162 maps an input to the neural network to one or more embeddings, e.g., an embedding for each of one or more data elements included in the input, and then, in some implementations, uses a positional encoding layer 163 to process the one or more embeddings to add positional encodings, e.g., a positional encoding for each of the one or more data elements included in the input, to the one or more embeddings. Some common examples of the positional encoding layer 163 include sinusoidal positional encoding layer and rotary positional encoding layer.

An “embedding” can generally refer to an ordered collection of numerical values, e.g., a vector, matrix, or other tensor of numerical values. There are many ways of generating an embedding. For example, a word or wordpiece may be mapped to an embedding in accordance with an embedding table or by a neural network. The raw value of a pixel or of a digitized audio waveform may itself be the embedding or may alternatively mapped to an embedding by a neural network.

Each of the attention blocks (or “blocks” for short) in the sequence of N attention blocks 164 receives a block input and processes the block input to generate a block output based on the block input. For the first block in the sequence, the block input includes the embeddings generated by the input embedding layer 162, and, for each block other than the first block in the sequence, the block input can be the block output of the preceding block in the sequence.

Being referred to as an “attention block” means that each block includes an attention mechanism. There are many different types of attention mechanisms that may be used. In some cases, the sequence of N attention blocks 164 can include a self-attention block that includes a self-attention mechanism. In some cases, the sequence of N attention blocks 164 can include a cross-attention block that includes a cross-attention mechanism. In some cases, the sequence of N attention blocks 164 can include both a self-attention block and a cross-attention block.

More generally, the sequence of N attention blocks 164 can include any number of attention blocks that can be arranged in any appropriate configuration. For example, all of the attention blocks 164 can be self-attention blocks. As another example, the sequence of N attention blocks 164 can include multiple cross-attention blocks that are arranged in a stack one after the other, followed by multiple self-attention blocks that are arranged in another stack one after the other. As another example, the sequence of N attention blocks 164 can include multiple cross-attention blocks and multiple self-attention blocks, where the local cross-attention blocks and the self-attention blocks are interleaved.

Each attention block 164 in the sequence of N attention blocks can include a multi-head attention sub-layer 166 and a multi-layer perceptron (MLP) 168. In some cases, the multi-head attention sub-layer 166 can be arranged subsequent to the multi-layer perceptron 168, as illustrated in FIG. 2, while in other cases, the multi-head attention sub-layer 166 can be arranged in parallel with the multi-layer perceptron 168, i.e., they both receive the same input data.

The multi-head attention sub-layer 166 includes one or more attention heads, followed by a linear layer. Similar to a “block,” a “head” refers to a group of one or more neural network layers in a neural network.

The multi-layer perceptron 168 includes one or more fully connected layers. For example, the multi-layer perceptron can include a first fully connected layer, followed by an activation layer, e.g., a non-linear elementwise activation layer, followed by a second fully connected layer. Examples of the activation layer include ReLU activation layer, sigmoid activation layer, Gaussian Error Linear Units activation layer, Swish activation layer, and so on. Each fully connected layer applies an affine transformation to the input to the layer, e.g., multiplies an input vector to the fully connected layer by a fully connected layer weight matrix that represents weights of the fully connected layer.

Each attention head in the multi-head attention sub-layer 166 generates a set of queries by applying a query linear transformation using a query transformation layer, generates a set of keys by applying a key linear transformation using a key transformation layer, and generates a set of values by applying a value linear transformation using a value transformation layer, and then applies any of a variety of variants of query-key-value (QKV) attention, e.g., a dot product attention function or a scaled dot product attention function, using the queries, keys, and values to generate an output for the attention mechanism.

Each query, key, value can be a vector that includes one or more vector elements. Applying a transformation by using a transformation layer (e.g., a query transformation layer) can include multiplying an input vector to the transformation layer by a weight matrix that represents weights of the transformation layer (e.g., a query matrix that represents weights of the query transformation layer). When there are multiple attention heads, the multi-head attention sub-layer then combines the outputs of the multiple attention heads, e.g., by concatenating the outputs and, optionally, processing the concatenated outputs through a linear layer to generate the output for the attention mechanism.

Examples of QKV attention variants are described in Vaswani, et al, Attention Is All You Need, arXiv:1706.03762, Raffel, et al, Exploring the Limits of Transfer Learning with a Unified Text-to-Text Transformer, arXiv:1910.10683, Devlin et al, BERT: Pre-training of Deep Bidirectional Transformers for Language Understanding, arXiv:1810.04805, Dai, et al, Transformer-XL: Attentive Language Models Beyond a Fixed-Length Context, arXiv:1901.02860, and Kitaev, et al, Reformer: The Efficient Transformer, arXiv: 2001.04451, the entire contents of which are hereby incorporated by reference herein in their entirety.

Each attention block 164 can optionally include one or more additional layers. For example, in some cases, each attention block 164 also includes a residual connection layer that combines the output of the multi-head attention sub-layer 166 with the input to the multi-head attention sub-layer 166 to generate a multi-head attention sub-layer residual output. Likewise, in some cases, each attention block 164 also includes a residual connection layer that combines the output of the multi-layer perceptron 168 with the input to the multi-layer perceptron 168 to generate a multi-layer perceptron residual output. As another example, in some cases, each attention block 164 also includes a layer normalization layer 170 that applies layer normalization to the multi-head attention sub-layer residual output. Likewise, in some cases, each attention block 164 also includes a layer normalization layer 172 that applies layer normalization to the multi-layer perceptron residual output.

The linear layer 174 applies a learned linear transformation to the output of the last attention block in the sequence in order to project the output of the last attention block into the appropriate space for processing by the output head 176 to generate an output of the neural network 110. Applying the learned linear transformation can multiply an input vector to the linear layer 174 that represents the output of the last attention block in the sequence by a linear layer weight matrix that represents weights of the linear layer.

The output head 176 includes one or more output layers. In some cases, the one or more output layers include a softmax layer. The softmax layer applies a softmax function over the output of the linear layer 174 or data derived from the output of the linear layer 174 or both to generate the probability distribution over a set of possible outputs. In these cases, the neural network 110 can then select an output from the set of possible outputs using the probability distribution.

For example, the set of possible outputs can be a vocabulary of tokens. The tokens can include any of a variety of tokens that represent text symbols or other symbols. As a particular example, the tokens can include one or more of characters, sub-words, words, punctuation marks, numbers, or other symbols that appear in a corpus of natural language text and/or computer code.

Referring back to FIG. 1B, the training system 100 implements a continual training framework to train the neural network 110 by using an architecture expansion engine 130. Under the continual training framework, the architecture of the neural network 110 and, correspondingly, the number of the weights 116 of the neural network 110, are progressively expanded, e.g., increased, throughout the training to enable efficient training pipelines for larger and more powerful models. Merely as an example, the initial architecture may have 1 billion weights, which can later be expanded to have 2 billion weights, 5 billion weights, 10 billion weights, or more while the neural network 110 is being trained under the continual training framework.

Rather than training each expanded (larger) neural network from scratch, e.g., from randomly initialized values of the weights of the neural network, the architecture expansion engine 130 is capable of expanding the architecture of the neural network 110 to increase its capacity during training by reusing the weights of previously trained (smaller) neural networks.

That is, the training system 100 begins with training the neural network 110 having the baseline architecture on training data 120 to perform one or more tasks to determine trained values of the weights 116 of the neural network that are included in the baseline architecture.

Next, the training system 100 uses the architecture expansion engine 130 to expand the baseline architecture of the neural network 110, i.e., to modify the neural network 110 to have an expanded architecture. The training system 100 then trains the neural network 110 having the expanded architecture on training data 120 to perform one or more tasks to determine trained values of the weights 116 of the neural network that are included in the expanded architecture.

The expanded architecture includes some or all of the existing neural network components of the baseline architecture. The expanded architecture also includes one or more new neural network components, and thus includes an additional set of weights that were previously not included in the baseline architecture.

For example, the expanded architecture can include an additional component, e.g., an additional block, relative to the baseline architecture. Correspondingly, the weights of such an additional component were previously not included in the baseline architecture. As another example, the expanded architecture can include an expanded component in place of an original component, e.g., an expanded multi-layer perceptron or an expanded block, that has an increased internal or hidden dimension relative to the original component in the baseline architecture. Analogously, the weights that make up the additional dimension were previously not included in the baseline architecture.

Further, the training system 100 uses the architecture expansion engine 130 to further expand the expanded architecture of the neural network 110, i.e., to modify the neural network 110, the architecture of which has now already been expanded once, to have a further expanded architecture. The training system 100 then trains the neural network 110 having the further expanded architecture on training data 120 to perform one or more tasks to determine trained values of the weights 116 of the neural network that are included in the further expanded architecture.

Likewise, the further expanded architecture includes some or all of the existing neural network components of the expanded architecture, and hence, includes some or all of the existing neural network components of the baseline architecture. The further expanded architecture also includes one or more new neural network components, and thus includes an additional set of weights that were previously not included in the expanded architecture.

Under the continual training framework, the training system 100 can repeatedly expand the architecture of the neural network 110 during the training of the neural network 110.

In particular, the architecture expansion engine 130 expands the architecture of the neural network 110 so that the expanded architecture shares some common weights with the baseline architecture, i.e., the neural network 110 having the expanded architecture includes some or all of the existing weights of the neural network 110 having the baseline architecture, and the training system 100 continues to adjust the values of these common weights during the continued training of the neural network 110 having the expanded architecture.

Additionally, the architecture expansion engine 130 imposes initialization constraints on the additional set of weights so as to expand the capacity of the model while preserving functionality, i.e., without losing training progress. The initialization constraints thereby allow for transfer of knowledge from the neural network 110 having the baseline architecture (or more broadly, any previously trained smaller models).

Thus, performing function-preserving expansions refers to extending the architecture of a neural network to increase its scale while keeping its functions unaltered, thus allowing to introduce new weights to store additional knowledge while preserving the knowledge acquired so far.

In particular, prior to training the neural network 110 having the expanded architecture, the architecture expansion engine 130 initializes a subset of the additional set of weights to be all zeros to achieve function-preserving expansions. Thus, the expanded architecture has some weight values that are the same as the baseline architecture, some other weight values that are set to zeros, and, in some cases, some further weight values that are randomly initialized.

The training system 100 then trains the trains the neural network having the expanded architecture on training data 120 starting from the trained values of the weights of the baseline architecture that are shared with the expanded architecture and from the zero initialized values for (the subset of) the additional set of weights.

In some cases, the training data 120 used to train the neural networks having different architectures (e.g., baseline and expanded architectures) can be at least partially the same while in other cases, distinct training data is used to train different neural networks. For example, the training system 100 can iterate through a list of existing training datasets included in the training data 120 and expand the architecture of the neural network 110 after the neural network 110 has been trained on each of the existing training datasets.

As another example, the training system 100 can continue the training process indefinitely, i.e., resume the training whenever a new training dataset becomes available, by generate an expanded architecture for the neural network and then training the neural network having the expanded architecture on the newly available training dataset.

Generally, the training data 120 includes multiple training examples. Each training example includes a training input, e.g., a training sequence, and, optionally, a corresponding target output for the training input, i.e., a target output to be generated by the neural network 110 by processing the training input for the machine learning task.

The training system 100 performs the training over multiple training iterations. At each training iteration, the training system 100 updates the weights 116 of the neural network 110, e.g., to generate updated values of the weights 116 from their current values, by performing a forward pass through the neural network using the training inputs obtained from the training dataset and then perform a backward pass through appropriate weights of the neural network 110 to compute the respective gradients through backpropagation.

The training system 100 trains the neural network 110 to minimize a loss function for the machine learning task. The loss function can be any appropriate loss function for the machine learning task.

For example, the machine learning task can be a next token prediction task or another language modeling pre-training task, and the loss function can be a next token prediction loss or other unsupervised or self-supervised loss. A next token prediction task is a pre-training task that requires the neural network 110 to predict the next token in a training sequence given the preceding tokens in the training.

More generally, the loss function includes one or more terms that measure, for each training input, the quality of a training output for the training input generated by performing a forward pass through the neural network, e.g., relative to a respective target output for the training input.

Some common examples of the loss terms include cross entropy loss terms, mean squared error loss terms, negative log likelihood loss terms, to name just a few. The loss function can also include other terms, e.g., regularization terms, auxiliary loss terms, unsupervised learning loss terms, and so on, that do not depend on the target outputs for the training inputs.

After training, the training system 100 can output the data specifying the trained neural network 110 for deployment. For example, the training system 100 or a different inference system 150 deploys the trained neural network 110 on one or more computing devices to perform inference, i.e., to generate new network outputs 114 for the machine learning task for new network inputs 112. Optionally, the training system 100 or the different inference system 150 can further fine-tune some or all of the weights 116 of the neural network 110 before deploying the neural network 110, e.g., using a different optimizer or on a different loss function.

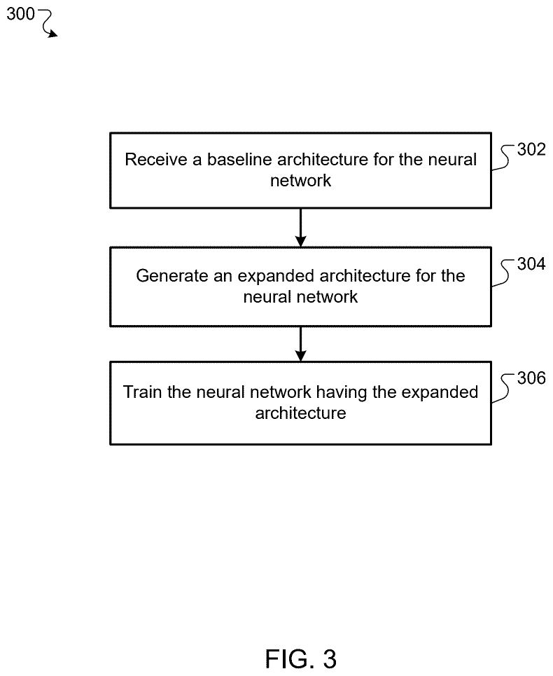

FIG. 3 is a flow diagram of an example process 300 for training a neural network using a continual training framework. For convenience, the process 300 will be described as being performed by a system of one or more computers located in one or more locations. For example, a training system, e.g., the training system 100 depicted in FIG. 1, appropriately programmed in accordance with this specification, can perform the process 300.

The system obtains data that specifies a baseline architecture for the neural network (step 302). The baseline architecture includes an input embedding layer, a positional encoding layer, a sequence of N blocks, where N can be any positive integer greater than or equal to one, a linear layer, and an output head. Each of the N blocks includes (i) a multi-head attention sub-layer that includes a plurality of attention heads and a linear layer, and (ii) a multi-layer perceptron (MLP) that includes a first fully connected layer followed by a second fully connected layer.

The baseline architecture can be obtained in any of a variety of possible ways. For example, the system can receive the source code defining the baseline architecture of the neural network as an upload from a remote user of the system over a data communication network, e.g., using an interface made available by the system. The interface can be a command-line interface (CLI), a graphical user interface (GUI), an application programming interface (API), or various combinations of the three and possibly another user interface (e.g., a web browser as user interface).

As another example, the system can receive an input from a user specifying which data, e.g., source code, that is already maintained by the system, or another system that is accessible by the system should be used as the data that defines the baseline architecture of the neural network.

As yet another example, the baseline architecture can be determined as a result of training of the neural network that has already occurred under the continual training framework. That is, the baseline architecture can be a previously expanded architecture that was generated from, e.g., an initial architecture or a further previously expanded architecture of the neural network.

The system generates an expanded architecture for the neural network (step 304). The expanded architecture includes some or all of the existing neural network components of the baseline architecture. The expanded architecture also includes one or more new neural network components, and thus includes an additional set of weights that were previously not included in the baseline architecture.

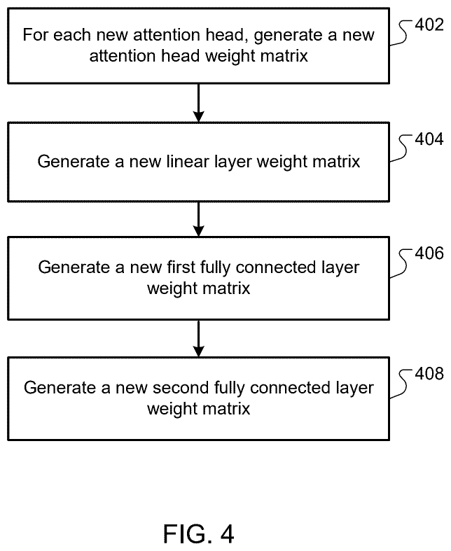

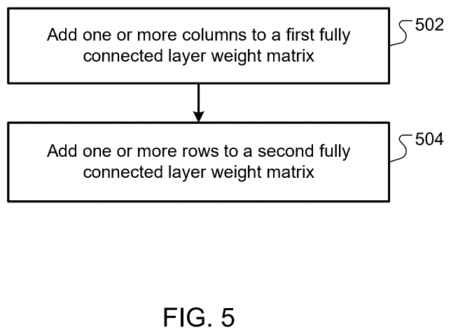

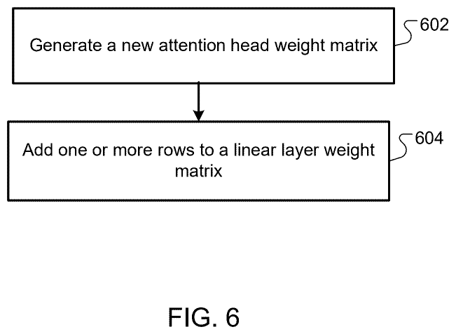

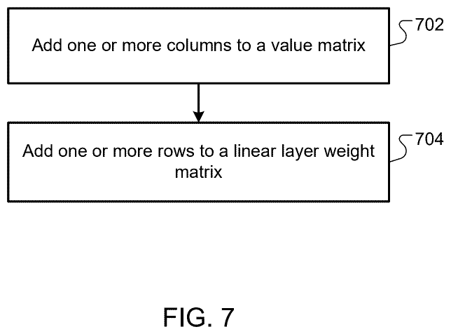

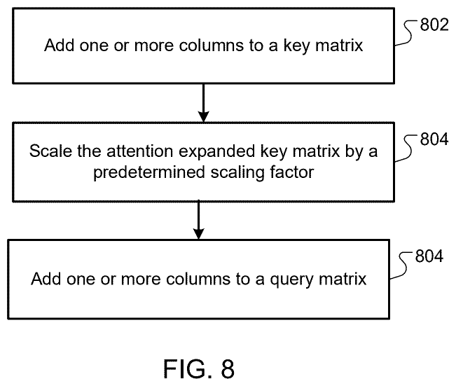

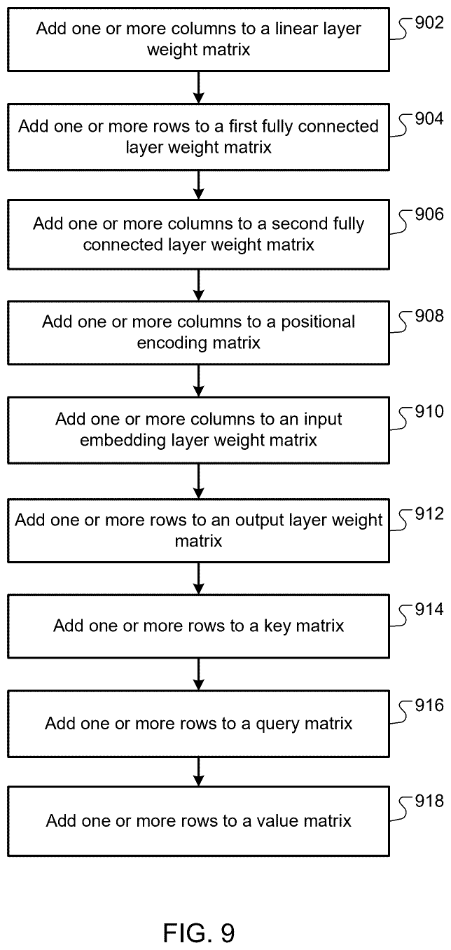

The expanded architecture can be generated in any one of six different ways. One way of performing step 304 is discussed further below with reference to FIG. 4, which describes generating an expanded architecture that includes N+1 blocks. Another way of performing step 304 is discussed further below with FIG. 5, which describes generating an expanded architecture that includes a MLP expanded block in place of one of the N blocks. Another way of performing step 304 is discussed further below with FIG. 6, which describes generating an expanded architecture that includes a larger block in place of one of the N blocks. Another way of performing step 304 is discussed further below with FIG. 7, which describes generating an expanded architecture that includes a head expanded block in place of one of the N blocks. Another way of performing step 304 is discussed further below with FIG. 8, which describes generating an expanded architecture that includes an attention expanded block in place of one of the N blocks. A further way of performing step 304 is discussed further below with FIG. 9, which describes generating an expanded architecture that includes a hidden dimension expanded block in place of one of the N blocks.

The system trains the neural network having the expanded architecture on training data that includes multiple training examples to determine updated, e.g., trained, values of the weights included in the expanded architecture, based on minimizing a loss function for a machine learning task that the neural network is being trained to perform (step 306).

The system can do this by computing, for each training example in multiple batches of training examples sampled from the training data, respective gradients of the loss function with respect to the weights of the neural network by backpropagation through the appropriate weights of the neural network. The system can then determine the updates by applying an update rule, e.g., an Adam update rule, an Rmsprop update rule, or a stochastic gradient descent (SGD) update rule, to the respective gradients.

Depending on the way the system performed step 304, i.e., depending on how the expanded architecture of the neural network is generated, the system can train the neural network beginning from different weight values when performing step 306. As a general example, the system can train the neural network beginning from some weight values that are the same as the baseline architecture, some other weight values that are set to zeros, and, in some cases, some further weight values that are randomly initialized.

By repeatedly performing one or more iterations of the process 300, the system can generate the trained neural network. In some implementations, the ways in which step 304 of the process 300 are performed stay the same across the one or more iterations. In other implementations, the ways in which step 304 of the process 300 are performed differ from one iteration to another iteration. Hence, at one iteration of the process 300, the neural network having the baseline architecture as of step 302 will be expanded to have an expanded architecture in a way that is different from how it is expanded in another iteration of the process 300.

FIG. 4 is a flow diagram of sub-steps 402-408 of step 304 of the process of FIG. 3. By performing sub-steps 402-408, the system can generate an expanded architecture of the neural network that includes N+1 blocks, i.e., can generate the expanded architecture by adding an additional, new block to the existing blocks included in the baseline architecture. The new block can be inserted at any depth of the neural network, i.e., inserted before or after any one of the existing blocks of the neural network.

The new block includes (i) a new multi-head attention sub-layer that includes a plurality of new attention heads and a new linear layer, and (ii) a new multi-layer perceptron that includes a new first fully connected layer followed by a new second fully connected layer.

For each of the plurality of new attention heads that are included the new multi-head attention sub-layer, the system generates a new attention head weight matrix that represents weights of the new attention head (step 402). In implementations the new attention head weight matrix can, in turn, be composed of multiple new matrices (or new sub-matrices) including a new query matrix (that represents weights of a new query transformation layer included in the new attention head), a new key matrix (that represents weights of a new key transformation layer included in the new attention head), and a new value matrix (that represents weights of a new value transformation layer included in the new attention head).

The system can generate the entries of the new attention head weight matrix to have any values. That is, the weights of each of the plurality of new attention heads can be set to any values. For example, the system can do this by assigning weight values randomly, sampling the weight values from some distribution, or setting the weight values to initial values that are dependent on, e.g., equal to, current values of some of the weights that are determined as a result of the training that has already occurred.

The system generates a new linear layer weight matrix that represents weights of the new linear layer included in the new multi-head attention sub-layer included in the new block (step 404). The system imposes initialization constraints on the weights of the new linear layer. In particular, the system generates the new linear layer weight matrix to have all zeros. That is, the weights of new linear layer are set to zeros.

The system generates a new first fully connected layer weight matrix that represents weights of a new first fully connected layer included in the new block (step 406). The system can generate the entries of the new first fully connected layer weight matrix to have any values. That is, the weights of the new first fully connected layer can be set to any values.

The system generates a new second fully connected layer weight matrix that represents weights of a new second fully connected layer included in the new block. That is, the new second fully connected layer weight matrix has all zeros (step 408). The system imposes initialization constraints on the weights of the new second fully connected layer. In particular, the system generates the new second fully connected layer weight matrix to have all zeros. That is, the weights of new second fully connected layer are set to zeros.

In the example of FIG. 4, at step 306 of the process 300, the system trains the neural network having the expanded architecture, which includes a new block, on training data beginning from weight values defined by the new attention head weight matrices, the new linear layer weight matrix that has all zeros, the new first fully connected layer weight matrix, and the new second fully connected layer weight matrix that has all zeros, to determine trained values for the weights included in the expanded architecture (which can then be used as the baseline architecture in the further training of the neural network under the continual training framework).

FIG. 5 is a flow diagram of sub-steps 502-504 of step 304 of the process of FIG. 3. By performing sub-steps 502-504, the system can generate an expanded architecture of the neural network that includes a MLP expanded block in place of one of the N blocks. The MLP expanded block can replace any one of the existing blocks. The MLP expanded block is capable of generating a MLP output that has a greater dimension than the MLP output generated by any one of the N blocks included in the baseline architecture.

The MLP expanded block includes an expanded multi-layer perceptron in place of a multi-layer perceptron included in the one of the N blocks. The expanded multi-layer perceptron includes an expanded first fully connected layer followed by an expanded second fully connected layer.

The system adds one or more columns to a first fully connected layer weight matrix that represents weights of a first fully connected layer included in the multi-layer perceptron to generate the expanded first fully connected layer weight matrix that represents weights of the expanded first fully connected layer included in the expanded multi-layer perceptron (step 502). The system can generate the entries of the one or more columns to have any values.

The system adds one or more rows to a second fully connected layer weight matrix that represents weights of a second fully connected layer included in the multi-layer perceptron to generate an expanded second fully connected layer weight matrix that represents weights of the expanded second fully connected layer included in the expanded multi-layer perceptron (step 504).

The system imposes initialization constraints on some of the weights of the expanded second fully connected layer. In particular, the system generates the one or more rows that are being added to the second fully connected layer weight matrix to have all zeros. That is, some of the weights of expanded second fully connected layer (that are represented by the one or more added rows) are set to zeros, while others of the weights of expanded second fully connected layer (that are represented by the existing rows) are determined as a result of the training that has already occurred.

In the example of FIG. 5, at step 306 of the process 300, the system trains the neural network having the expanded architecture, which includes a MLP expanded block in place of one of the N blocks, on training data beginning from weight values defined by the expanded first fully connected layer weight matrix, and the expanded second fully connected layer weight matrix that has the one or more added rows that have all zeros, to determine trained values for the weights included in the expanded architecture (which can then be used as the baseline architecture in the further training of the neural network under the continual training framework).

FIG. 6 is a flow diagram of sub-steps 602 of step 304 of the process of FIG. 3. By performing sub-steps 602-604, the system can generate an expanded architecture of the neural network that includes a larger block in place of one of the N blocks. The larger block can replace any one of the existing blocks.

The larger block includes a larger multi-head attention sub-layer in place of a multi-head attention sub-layer included in the one of the N blocks. The larger multi-head attention sub-layer includes a plurality of attention heads included in the multi-head attention sub-layer and an additional attention head. The larger block also includes a larger linear layer in place of a linear layer included in the multi-head attention sub-layer.

The system generates a new attention head weight matrix that represents weights of the additional attention head included in the larger multi-head attention sub-layer (step 602). In implementations the new attention head weight matrix can, in turn, be composed of multiple new matrices (or new sub-matrices) including a new query matrix, a new key matrix, and a new value matrix. The system can generate the entries of the new attention head weight matrix to have any values.

The system adds one or more rows to a linear layer weight matrix that represents weights of the linear layer to generate a larger linear layer weight matrix that represents weights of the larger linear layer (step 604).

The system imposes initialization constraints on some of the weights of the larger linear layer. In particular, the system generates the one or more rows that are being added to the linear layer weight matrix to have all zeros. That is, some of the weights of larger linear layer (that are represented by the one or more added rows) are set to zeros, while others of the weights of larger linear layer (that are represented by the existing rows) are determined as a result of the training that has already occurred.

In the example of FIG. 6, at step 306 of the process 300, the system trains the neural network having the expanded architecture, which includes a larger block in place of one of the N blocks, on training data beginning from weight values defined by the new attention head weight matrix, and the larger linear layer weight matrix that has the one or more added rows that have all zeros, to determine trained values for the weights included in the expanded architecture (which can then be used as the baseline architecture in the further training of the neural network under the continual training framework).

FIG. 7 is a flow diagram of sub-steps 702-704 of step 304 of the process of FIG. 3. By performing sub-steps 702-704, the system can generate an expanded architecture of the neural network that includes a head expanded block in place of one of the N blocks. The head expanded block can replace any one of the existing blocks. The head expanded block is capable of generating a head output that has a greater dimension than the head output generated by any one of the N blocks included in the baseline architecture.

The head expanded block includes a head expanded attention head in place of one of a plurality of attention heads included in the one of the N blocks. The head expanded attention head includes (i) a head expanded value transformation layer in place of a value transformation layer included in the one of the plurality of attention heads and (ii) a head expanded linear layer in place of a linear layer included in the one of the N blocks.

The system adds one or more columns to a value matrix that represents weights of the value transformation layer to generate a head expanded value matrix that represents weights of the head expanded value transformation layer (step 702). The system can generate the entries of the one or more columns to have any values.

The system adds one or more rows to a linear layer weight matrix that represents weights of the linear layer to generate a head expanded linear layer weight matrix that represents weights of the head expanded linear layer (step 704).

The system imposes initialization constraints on some of the weights of the head expanded linear layer. In particular, the system generates the one or more rows that are being added to the linear layer weight matrix to have all zeros. That is, some of the weights of head expanded linear layer (that are represented by the one or more added rows) are set to zeros, while others of the weights of head expanded linear layer (that are represented by the existing rows) are determined as a result of the training that has already occurred.

In the example of FIG. 7, at step 306 of the process 300, the system trains the neural network having the expanded architecture, which includes a head expanded block in place of one of the N blocks, on training data beginning from weight values defined by the head expanded value matrix, and the head expanded linear layer weight matrix that has the one or more added rows that have all zeros, to determine trained values for the weights included in the expanded architecture (which can then be used as the baseline architecture in the further training of the neural network under the continual training framework).

FIG. 8 is a flow diagram of sub-steps 802-806 of step 304 of the process of FIG. 3. By performing sub-steps 802-806, the system can generate an expanded architecture of the neural network that includes an attention expanded block in place of one of the N blocks. The attention expanded block can replace any one of the existing blocks. The attention expanded block is capable of generating keys and queries that have greater dimensions than the keys and queries generated by any one of the N blocks included in the baseline architecture.

The attention expanded block includes an attention expanded attention head in place of one of a plurality of attention heads included in the one of the N blocks. The attention expanded attention head includes (i) an attention expanded key transformation layer in place of a key transformation layer included in the one of the plurality of attention heads and (ii) an attention expanded query transformation layer in place of a query transformation layer included in the one of the plurality of attention heads.

The system adds one or more columns to a key matrix that represents weights of the key transformation layer to generate an attention expanded key matrix that represents weights of the attention expanded key transformation layer (step 802).

The system imposes initialization constraints on some of the weights of the attention expanded key transformation layer. In particular, the system generates the one or more columns that are being added to the key matrix to have all zeros. That is, some of the weights of attention expanded key transformation layer (that are represented by the one or more added columns) are set to zeros, while others of the weights of attention expanded key transformation layer (that are represented by the existing columns) are determined as a result of the training that has already occurred.

The system scales the attention expanded key matrix by a predetermined scaling factor (step 804). That is, the system multiplies a predetermined scaling factor to each entry in the attention expanded key matrix. In implementations the predetermined scaling factor can be \sqrt{\tilde{k}}/\sqrt{k}, where k is the number of columns of the key matrix, and \tilde{k} is the number of columns of the attention expanded key matrix.

The system adds one or more columns to a query matrix that represents weights of the query transformation layer to generate an attention expanded query matrix that represents weights of the attention expanded query transformation layer (step 806). The system can generate the entries of the one or more columns to have any values.

In the example of FIG. 8, at step 306 of the process 300, the system trains the neural network having the expanded architecture, which includes an attention expanded block in place of one of the N blocks, on training data beginning from weight values defined by the scaled attention expanded value matrix that has the one or more added columns that have all zeros, and the attention expanded query matrix, to determine trained values for the weights included in the expanded architecture (which can then be used as the baseline architecture in the further training of the neural network under the continual training framework).

FIG. 9 is a flow diagram of sub-steps 902-918 of step 304 of the process of FIG. 3. By performing sub-steps 902-918, the system can generate an expanded architecture of the neural network that includes a hidden dimension expanded block in place of one of the N blocks. The hidden dimension expanded block can replace any one of the existing blocks. The hidden dimension expanded block is capable of generating a block output that has a larger dimension than a block output generated by any one of the N blocks included in the baseline architecture.

The hidden dimension expanded block includes a hidden dimension expanded multi-head attention sub-layer. The hidden dimension expanded multi-head attention sub-layer includes a hidden dimension expanded linear layer in place of a linear layer included in the one of the N blocks. The hidden dimension expanded multi-head attention sub-layer also includes (i) a hidden dimension expanded key transformation layer in place of a key transformation layer included in the one of the N blocks, (ii) a hidden dimension expanded query transformation layer in place of a query transformation layer included in the one of the N blocks, and (iii) a hidden dimension expanded value transformation layer in place of a value transformation layer included in the one of the N blocks

The hidden dimension expanded block also includes a hidden dimension expanded multi-layer perceptron. The hidden dimension expanded multi-layer perceptron includes a hidden dimension expanded first fully connected layer in place of a first fully connected layer included in the one of the N blocks, followed by a hidden dimension expanded second fully connected layer in place of a second fully connected layer included in the one of the N blocks.

The expanded architecture also includes a hidden dimension expanded positional encoding layer in place of a positional encoding layer included in the baseline architecture. The expanded architecture further includes (i) a hidden dimension expanded input embedding layer in place of an input embedding layer included in the baseline architecture and (ii) a hidden dimension expanded output layer in place of an output layer included in the baseline architecture.

The system adds one or more columns to a linear layer weight matrix that represents weights of the linear layer to generate a hidden dimension expanded linear layer weight matrix that represents weights of the hidden dimension expanded linear layer (step 902).

The system imposes initialization constraints on some of the weights of the hidden dimension expanded linear layer. In particular, the system generates the one or more columns that are being added to the linear layer weight matrix to have all zeros. That is, some of the weights of the hidden dimension expanded linear layer (that are represented by the one or more added columns) are set to zeros, while others of the weights of the hidden dimension expanded linear layer (that are represented by the existing columns) are determined as a result of the training that has already occurred.

The system adds one or more rows to a first fully connected layer weight matrix that represents weights of the first fully connected layer to generate a hidden dimension expanded first fully connected layer weight matrix that represents weights of the hidden dimension expanded first fully connected layer (step 904). The system can generate the entries of the one or more rows to have any values.

The system adds one or more columns to a second fully connected layer weight matrix that represents weights of the second fully connected layer to generate a hidden dimension expanded second fully connected layer weight matrix that represents weights of the hidden dimension expanded second fully connected layer (step 906).

The system imposes initialization constraints on some of the weights of the hidden dimension expanded second fully connected layer. In particular, the system generates the one or more columns that are being added to the second fully connected layer weight matrix to have all zeros. That is, some of the weights of the hidden dimension expanded second fully connected layer (that are represented by the one or more added columns) are set to zeros, while others of the weights of the hidden dimension expanded second fully connected layer (that are represented by the existing columns) are determined as a result of the training that has already occurred.

The system adds one or more columns to a positional encoding matrix that represents weights of the positional encoding layer to generate a hidden dimension expanded positional encoding matrix that represents weights of the hidden dimension expanded positional encoding layer (step 908).

The system imposes initialization constraints on some of the weights of the hidden dimension expanded positional encoding layer. In particular, the system generates the one or more columns that are being added to the positional encoding matrix to have all zeros. That is, some of the weights of the hidden dimension expanded positional encoding layer (that are represented by the one or more added columns) are set to zeros, while others of the weights of the hidden dimension expanded positional encoding layer (that are represented by the existing columns) are determined as a result of the training that has already occurred.

The system adds one or more columns to an input embedding layer weight matrix that represents weights of the input embedding layer to generate a hidden dimension expanded input embedding layer weight matrix that represents weights of the hidden dimension expanded input embedding layer (step 910). The system can generate the entries of the one or more columns to have any values.

The system adds one or more rows to an output layer weight matrix that represents weights of the output layer to generate a hidden dimension expanded output layer weight matrix that represents weights of the hidden dimension expanded output layer (step 912). The system can generate the entries of the one or more rows to have any values.

The system adds one or more rows to a key matrix that represents weights of the key transformation layer to generate a hidden dimension expanded key matrix that represents weights of the hidden dimension expanded key transformation layer (step 914). The system can generate the entries of the one or more rows to have any values.

The system adds one or more rows to a query matrix that represents weights of the query transformation layer to generate a hidden dimension expanded query matrix that represents weights of the hidden dimension expanded query transformation layer (step 916). The system can generate the entries of the one or more rows to have any values.

The system adds one or more rows to a value matrix that represents weights of the value transformation layer to generate a hidden dimension expanded value matrix that represents weights of the hidden dimension expanded value transformation layer (step 918). The system can generate the entries of the one or more rows to have any values.

In the example of FIG. 9, at step 306 of the process 300, the system trains the neural network having the expanded architecture, which includes (i) a hidden dimension expanded block in place of one of the N blocks, (ii) a hidden dimension expanded positional encoding layer in place of a positional encoding layer, (iii) a hidden dimension expanded input embedding layer in place of an input embedding layer, and (iv) a hidden dimension expanded output layer in place of an output layer, on training data beginning from weight values defined by (i) the hidden dimension expanded linear layer weight matrix that has the one or more added columns that have all zeros, (ii) the hidden dimension expanded first fully connected layer weight matrix, (iii) the hidden dimension expanded second fully connected layer weight matrix that has the one or more added columns that have all zeros, (iv) the hidden dimension expanded positional encoding matrix, (v) the hidden dimension expanded input embedding layer weight matrix, (vi) the output layer weight matrix, and (vii) the hidden dimension expanded key, query, and value matrices, to determine trained values for the weights included in the expanded architecture (which can then be used as the baseline architecture in the further training of the neural network under the continual training framework).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network, wherein the method comprises:
obtaining a baseline architecture for the neural network, wherein the baseline architecture comprises N blocks, and wherein each of the N blocks comprises (i) a multi-head attention sub-layer that comprises a plurality of attention heads and a linear layer, and (ii) a multi-layer perceptron that comprises a first fully connected layer followed by a second fully connected layer;
generating an expanded architecture for the neural network, wherein the expanded architecture comprises N+1 blocks, and wherein generating the expanded architecture comprises, generating a new block based on:
for each of a plurality of new attention heads included in a new multi-head attention sub-layer included in the new block, generating a new attention head weight matrix that represents weights of the new attention head;
generating a new linear layer weight matrix that represents weights of a new linear layer included in the new multi-head attention sub-layer included in the new block, the new linear layer weight matrix having all zeros;
generating a new first fully connected layer weight matrix that represents weights of a new first fully connected layer included in the new block; and
generating a new second fully connected layer weight matrix that represents weights of a new second fully connected layer included in the new block, the new second fully connected layer weight matrix having all zeros; and
training the neural network having the expanded architecture beginning from weight values defined by the new attention head weight matrices, the new linear layer weight matrix that has all zeros, the new first fully connected layer weight matrix, and the new second fully connected layer weight matrix that has all zeros.

2. The method of claim 1, wherein the expanded architecture for the neural network comprises a MLP expanded block in place of one of the N blocks, wherein the MLP expanded block comprises an expanded multi-layer perceptron in place of a multi-layer perceptron included in the one of the N blocks, wherein the expanded multi-layer perceptron comprises an expanded first fully connected layer followed by an expanded second fully connected layer, wherein generating the expanded architecture comprises, generating the expanded multi-layer perceptron based on:
adding one or more columns to a first fully connected layer weight matrix that represents weights of a first fully connected layer included in the multi-layer perceptron to generate an expanded first fully connected layer weight matrix that represents weights of the expanded first fully connected layer included in the expanded multi-layer perceptron; and
adding one or more rows to a second fully connected layer weight matrix that represents weights of a second fully connected layer included in the multi-layer perceptron to generate an expanded second fully connected layer weight matrix that represents weights of the expanded second fully connected layer included in the expanded multi-layer perceptron, the one or more added rows having all zeros, and wherein training the neural network having the expanded architecture comprises:
training the neural network having the expanded architecture beginning from weight values defined by the expanded first fully connected layer weight matrix, and the expanded second fully connected layer weight matrix that has the one or more added rows having all zeros.

3. The method of claim 1, wherein the expanded architecture for the neural network comprises a larger block in place of one of the N blocks, wherein the larger block comprises (i) a larger multi-head attention sub-layer in place of a multi-head attention sub-layer included in the one of the N blocks, wherein the larger multi-head attention sub-layer comprises a plurality of attention heads included in the multi-head attention sub-layer and an additional attention head, and (ii) a larger linear layer in place of a linear layer included in the multi-head attention sub-layer, wherein generating the expanded architecture comprises, generating the larger block based on:
adding one or more rows to a linear layer weight matrix that represents weights of the linear layer to generate a larger linear layer weight matrix that represents weights of the larger linear layer, the one or more added rows having all zeros, and wherein training the neural network having the expanded architecture comprises:
training the neural network having the expanded architecture beginning from weight values defined by the larger linear layer weight matrix that has the one or more added rows having all zeros.

4. The method of claim 1, wherein the expanded architecture for the neural network comprises a head expanded block in place of one of the N blocks, wherein the head expanded block comprises a head expanded attention head in place of one of a plurality of attention heads included in the one of the N blocks, wherein the head expanded attention head comprises (i) a head expanded value transformation layer in place of a value transformation layer included in the one of the plurality of attention heads and (ii) a head expanded linear layer in place of a linear layer included in the one of the N blocks, wherein generating the expanded architecture comprises, generating the head expanded block based on:
adding one or more columns to a value matrix that represents weights of the value transformation layer to generate a head expanded value matrix that represents weights of the head expanded value transformation layer; and
adding one or more rows to a linear layer weight matrix that represents weights of the linear layer to generate a head expanded linear layer weight matrix that represents weights of the head expanded linear layer, the one or more added rows having all zeros, and wherein training the neural network having the expanded architecture comprises:
training the neural network having the expanded architecture beginning from weight values defined by the head expanded value matrix, and the head expanded linear layer weight matrix that has the one or more added rows having all zeros.

5. The method of claim 1, wherein the expanded architecture for the neural network comprises an attention expanded block in place of one of the N blocks, wherein the attention expanded block comprises an attention expanded attention head in place of one of a plurality of attention heads included in the one of the N blocks, wherein the attention expanded attention head comprises (i) an attention expanded key transformation layer in place of a key transformation layer included in the one of the plurality of attention heads and (ii) an attention expanded query transformation layer in place of a query transformation layer included in the one of the plurality of attention heads, and wherein generating the expanded architecture comprises, generating the attention expanded block based on:
adding one or more columns to a key matrix that represents weights of the key transformation layer to generate an attention expanded key matrix that represents weights of the attention expanded key transformation layer, the one or more added columns having all zeros; and
adding one or more columns to a query matrix that represents weights of the query transformation layer to generate an attention expanded query matrix that represents weights of the attention expanded query transformation layer, and wherein training the neural network having the expanded architecture comprises:
training the neural network having the expanded architecture beginning from weight values defined by the attention expanded value matrix that has the one or more added columns having all zeros, and the attention expanded query matrix.

6. The method of claim 5, wherein generating the expanded key matrix comprises scaling the attention expanded key matrix by a predetermined scaling factor.

7. The method of claim 1, wherein the expanded architecture for the neural network comprises a hidden dimension expanded block in place of one of the N blocks, wherein the hidden dimension expanded block includes (i) a hidden dimension expanded multi-head attention sub-layer that comprises a hidden dimension expanded linear layer in place of a linear layer included in the one of the N blocks and (ii) a hidden dimension expanded multi-layer perceptron that comprises a hidden dimension expanded first fully connected layer in place of a first fully connected layer included in the one of the N blocks, followed by a hidden dimension expanded second fully connected layer in place of a second fully connected layer included in the one of the N blocks, and wherein generating the expanded architecture comprises, generating the hidden dimension expanded block based on:
adding one or more columns to a linear layer weight matrix that represents weights of the linear layer to generate a hidden dimension expanded linear layer weight matrix that represents weights of the hidden dimension expanded linear layer, the one or more added columns having all zeros;
adding one or more rows to a first fully connected layer weight matrix that represents weights of the first fully connected layer to generate a hidden dimension expanded first fully connected layer weight matrix that represents weights of the hidden dimension expanded first fully connected layer; and
adding one or more columns to a second fully connected layer weight matrix that represents weights of the second fully connected layer to generate a hidden dimension expanded second fully connected layer weight matrix that represents weights of the hidden dimension expanded second fully connected layer, the one or more added columns having all zeros, and wherein training the neural network having the expanded architecture comprises:
training the neural network having the expanded architecture beginning from weight values defined by the hidden dimension expanded linear layer weight matrix that has the one or more added columns having all zeros, the hidden dimension expanded first fully connected matrix that has the one or more added columns having all zeros.

8. The method of claim 7, wherein the expanded architecture comprises a hidden dimension expanded positional encoding layer in place of a positional encoding layer included in the baseline architecture, and wherein generating the expanded architecture comprises, generating the hidden dimension expanded positional encoding layer based on:
adding one or more columns to a positional encoding matrix that represents weights of the positional encoding layer to generate a hidden dimension expanded positional encoding matrix that represents weights of the hidden dimension expanded positional encoding layer, the one or more added columns having all zeros.

9. The method of claim 7, wherein the expanded architecture comprises a hidden dimension expanded input embedding layer in place of an input embedding layer included in the baseline architecture, and a hidden dimension expanded output layer in place of an output layer included in the baseline architecture, and wherein generating the expanded architecture comprises, generating the hidden dimension expanded network output layer based on:
adding one or more columns to an input embedding layer weight matrix that represents weights of the input embedding layer to generate a hidden dimension expanded input embedding layer weight matrix that represents weights of the hidden dimension expanded input embedding layer; and
adding one or more rows to an output layer weight matrix that represents weights of the output layer to generate a hidden dimension expanded output layer weight matrix that represents weights of the hidden dimension expanded output layer.

10. The method of claim 7, wherein the hidden dimension expanded multi-head attention sub-layer comprises a hidden dimension expanded key transformation layer in place of a key transformation layer included in the one of the N blocks, a hidden dimension expanded query transformation layer in place of a query transformation layer included in the one of the N blocks, and a hidden dimension expanded value transformation layer in place of a value transformation layer included in the one of the N blocks, and wherein generating the expanded architecture comprises, generating the hidden dimension expanded multi-head attention sub-layer based on:
adding one or more rows to a key matrix that represents weights of the key transformation layer to generate a hidden dimension expanded key matrix that represents weights of the hidden dimension expanded key transformation layer;
adding one or more rows to a query matrix that represents weights of the query transformation layer to generate a hidden dimension expanded query matrix that represents weights of the hidden dimension expanded query transformation layer; and
adding one or more rows to a value matrix that represents weights of the value transformation layer to generate a hidden dimension expanded value matrix that represents weights of the hidden dimension expanded value transformation layer.

11. The method of claim 1, further comprising outputting data specifying the trained neural network.

12. The method of claim 1, further comprising using the trained neural network to generate new outputs.

13. A system comprising one or more computers and one or more storage devices storing instructions that when executed by the one or more computers cause the one more computers to perform operations for training a neural network, wherein the operations comprise:
obtaining a baseline architecture for the neural network, wherein the baseline architecture comprises N blocks, and wherein each of the N blocks comprises (i) a multi-head attention sub-layer that comprises a plurality of attention heads and a linear layer, and (ii) a multi-layer perceptron that comprises a first fully connected layer followed by a second fully connected layer;
generating an expanded architecture for the neural network, wherein the expanded architecture comprises N+1 blocks, and wherein generating the expanded architecture comprises, generating a new block based on:
for each of a plurality of new attention heads included in a new multi-head attention sub-layer included in the new block, generating a new attention head weight matrix that represents weights of the new attention head;
generating a new linear layer weight matrix that represents weights of a new linear layer included in the new multi-head attention sub-layer included in the new block, the new linear layer weight matrix having all zeros;
generating a new first fully connected layer weight matrix that represents weights of a new first fully connected layer included in the new block; and
generating a new second fully connected layer weight matrix that represents weights of a new second fully connected layer included in the new block, the new second fully connected layer weight matrix having all zeros; and
training the neural network having the expanded architecture beginning from weight values defined by the new attention head weight matrices, the new linear layer weight matrix that has all zeros, the new first fully connected layer weight matrix, and the new second fully connected layer weight matrix that has all zeros.

14. The system of claim 13, wherein the expanded architecture for the neural network comprises a MLP expanded block in place of one of the N blocks, wherein the MLP expanded block comprises an expanded multi-layer perceptron in place of a multi-layer perceptron included in the one of the N blocks, wherein the expanded multi-layer perceptron comprises an expanded first fully connected layer followed by an expanded second fully connected layer, wherein generating the expanded architecture comprises, generating the expanded multi-layer perceptron based on:
adding one or more columns to a first fully connected layer weight matrix that represents weights of a first fully connected layer included in the multi-layer perceptron to generate an expanded first fully connected layer weight matrix that represents weights of the expanded first fully connected layer included in the expanded multi-layer perceptron; and
adding one or more rows to a second fully connected layer weight matrix that represents weights of a second fully connected layer included in the multi-layer perceptron to generate an expanded second fully connected layer weight matrix that represents weights of the expanded second fully connected layer included in the expanded multi-layer perceptron, the one or more added rows having all zeros, and wherein training the neural network having the expanded architecture comprises:
training the neural network having the expanded architecture beginning from weight values defined by the expanded first fully connected layer weight matrix, and the expanded second fully connected layer weight matrix that has the one or more added rows having all zeros.

15. The system of claim 13, wherein the expanded architecture for the neural network comprises a larger block in place of one of the N blocks, wherein the larger block comprises (i) a larger multi-head attention sub-layer in place of a multi-head attention sub-layer included in the one of the N blocks, wherein the larger multi-head attention sub-layer comprises a plurality of attention heads included in the multi-head attention sub-layer and an additional attention head, and (ii) a larger linear layer in place of a linear layer included in the multi-head attention sub-layer, wherein generating the expanded architecture comprises, generating the larger block based on:
adding one or more rows to a linear layer weight matrix that represents weights of the linear layer to generate a larger linear layer weight matrix that represents weights of the larger linear layer, the one or more added rows having all zeros, and wherein training the neural network having the expanded architecture comprises:
training the neural network having the expanded architecture beginning from weight values defined by the larger linear layer weight matrix that has the one or more added rows having all zeros.

16. The system of claim 13, wherein the expanded architecture for the neural network comprises a head expanded block in place of one of the N blocks, wherein the head expanded block comprises a head expanded attention head in place of one of a plurality of attention heads included in the one of the N blocks, wherein the head expanded attention head comprises (i) a head expanded value transformation layer in place of a value transformation layer included in the one of the plurality of attention heads and (ii) a head expanded linear layer in place of a linear layer included in the one of the N blocks, wherein generating the expanded architecture comprises, generating the head expanded block based on:
adding one or more columns to a value matrix that represents weights of the value transformation layer to generate a head expanded value matrix that represents weights of the head expanded value transformation layer; and
adding one or more rows to a linear layer weight matrix that represents weights of the linear layer to generate a head expanded linear layer weight matrix that represents weights of the head expanded linear layer, the one or more added rows having all zeros, and wherein training the neural network having the expanded architecture comprises:
training the neural network having the expanded architecture beginning from weight values defined by the head expanded value matrix, and the head expanded linear layer weight matrix that has the one or more added rows having all zeros.

17. The system of claim 13, wherein the expanded architecture for the neural network comprises an attention expanded block in place of one of the N blocks, wherein the attention expanded block comprises an attention expanded attention head in place of one of a plurality of attention heads included in the one of the N blocks, wherein the attention expanded attention head comprises (i) an attention expanded key transformation layer in place of a key transformation layer included in the one of the plurality of attention heads and (ii) an attention expanded query transformation layer in place of a query transformation layer included in the one of the plurality of attention heads, and wherein generating the expanded architecture comprises, generating the attention expanded block based on:
adding one or more columns to a key matrix that represents weights of the key transformation layer to generate an attention expanded key matrix that represents weights of the attention expanded key transformation layer, the one or more added columns having all zeros; and
adding one or more columns to a query matrix that represents weights of the query transformation layer to generate an attention expanded query matrix that represents weights of the attention expanded query transformation layer, and wherein training the neural network having the expanded architecture comprises:
training the neural network having the expanded architecture beginning from weight values defined by the attention expanded value matrix that has the one or more added columns having all zeros, and the attention expanded query matrix.

18. The system of claim 17, wherein generating the expanded key matrix comprises scaling the attention expanded key matrix by a predetermined scaling factor.

19. The system of claim 13, wherein the expanded architecture for the neural network comprises a hidden dimension expanded block in place of one of the N blocks, wherein the hidden dimension expanded block includes (i) a hidden dimension expanded multi-head attention sub-layer that comprises a hidden dimension expanded linear layer in place of a linear layer included in the one of the N blocks and (ii) a hidden dimension expanded multi-layer perceptron that comprises a hidden dimension expanded first fully connected layer in place of a first fully connected layer included in the one of the N blocks, followed by a hidden dimension expanded second fully connected layer in place of a second fully connected layer included in the one of the N blocks, and wherein generating the expanded architecture comprises, generating the hidden dimension expanded block based on:
adding one or more columns to a linear layer weight matrix that represents weights of the linear layer to generate a hidden dimension expanded linear layer weight matrix that represents weights of the hidden dimension expanded linear layer, the one or more added columns having all zeros;
adding one or more rows to a first fully connected layer weight matrix that represents weights of the first fully connected layer to generate a hidden dimension expanded first fully connected layer weight matrix that represents weights of the hidden dimension expanded first fully connected layer; and
adding one or more columns to a second fully connected layer weight matrix that represents weights of the second fully connected layer to generate a hidden dimension expanded second fully connected layer weight matrix that represents weights of the hidden dimension expanded second fully connected layer, the one or more added columns having all zeros, and wherein training the neural network having the expanded architecture comprises:
training the neural network having the expanded architecture beginning from weight values defined by the hidden dimension expanded linear layer weight matrix that has the one or more added columns having all zeros, the hidden dimension expanded first fully connected matrix that has the one or more added columns having all zeros.

20. One or more non-transitory computer storage media storing instructions that when executed by one or more computers cause the one more computers to perform operations for training a neural network, wherein the operations comprise:
obtaining a baseline architecture for the neural network, wherein the baseline architecture comprises N blocks, and wherein each of the N blocks comprises (i) a multi-head attention sub-layer that comprises a plurality of attention heads and a linear layer, and (ii) a multi-layer perceptron that comprises a first fully connected layer followed by a second fully connected layer;
generating an expanded architecture for the neural network, wherein the expanded architecture comprises N+1 blocks, and wherein generating the expanded architecture comprises, generating a new block based on:
for each of a plurality of new attention heads included in a new multi-head attention sub-layer included in the new block, generating a new attention head weight matrix that represents weights of the new attention head;
generating a new linear layer weight matrix that represents weights of a new linear layer included in the new multi-head attention sub-layer included in the new block, the new linear layer weight matrix having all zeros;
generating a new first fully connected layer weight matrix that represents weights of a new first fully connected layer included in the new block; and
generating a new second fully connected layer weight matrix that represents weights of a new second fully connected layer included in the new block, the new second fully connected layer weight matrix having all zeros; and
training the neural network having the expanded architecture beginning from weight values defined by the new attention head weight matrices, the new linear layer weight matrix that has all zeros, the new first fully connected layer weight matrix, and the new second fully connected layer weight matrix that has all zeros.
